(19) United States
(12) Patent Application Publication
(10) Pub. No.: US 2014/0305230 A1
(43) Pub. Date: Oct. 16, 2014

(54) SAMPLE DEPOSITION CHAMBER FOR LASER-INDUCED ACOUSTIC DESORPTION (LIAD) FOILS

(71) Applicant: Purdue Research Foundation, West Lafayette, IN (US)

(72) Inventors: David J. Borton, West Lafayette, IN (US); Nelson R. Vinueza Benitez, West Lafayette, IN (US); Lucas M. Amundson, West Lafayette, IN (US); Matthew R. Hurt, West Lafayette, IN (US); Hilkka I. Kenttämaa, West Lafayette, IN (US)

(21) Appl. No.: 14/359,515

(22) PCT Filed: Oct. 10, 2012
(86) PCT No.: PCT/US2012/059545

§ 371 Date: May 20, 2014

Related U.S. Application Data
(60) Provisional application No. 61/562,697, filed on Nov. 22, 2011.

(51) Int. Cl. G01N 35/10

(52) U.S. Cl. CPC G01N 35/10
USPC 73/864.81

(57) ABSTRACT

A system and method of preparing a target surface with an analyte sample is provided. A target preparation device includes a housing having a cavity. A target is positioned in the cavity of the housing. An exemplary method includes introducing an analyte solution into the cavity of the housing such that the analyte solution is in contact with the target surface and delivering a drying gas into the cavity to evaporate the solvent of the analyte solution and to deposit the analyte onto the target surface.

### CROSS REFERENCE TO RELATED APPLICATIONS

The present application is a nationalization under 35 U.S.C. §371 of International Application No. PCT/US2012/059545, filed Oct. 10, 2012, titled “Sample Deposition Chamber for Laser-Induced Acoustic Desorption (LIAD) Foils,” which claims the benefit of U.S. Provisional Application Ser. No. 61/562,697, filed Nov. 22, 2011, the disclosures of which are expressly incorporated by reference herein.

### STATEMENT OF GOVERNMENT RIGHTS

This invention was made with government support under910466 awarded by the National Science Foundation and DE-SC0008197 awarded by the Department of Energy. The government has certain rights in the invention.

### BACKGROUND AND SUMMARY OF THE INVENTION

The present invention relates to laser-induced acoustic desorption (LIAD). More particularly, the present invention relates to a method and apparatus for preparing an analyte sample for laser-induced acoustic desorption (LIAD).

Soft ionization techniques, such as electrospray ionization (ESI) and matrix-assisted laser desorption ionization (MALDI), are used to analyze thermally labile and nonvolatile analytes by mass spectrometry. Both ESI and MALDI involve ionization via protonation, deprotonation, or the attachment of a cation or an anion. ESI often ionizes the most polar components present, potentially leading to suppression of the analyte ion signal or the signals of the less polar molecules in mixtures. Each technique has limited applicability to nonpolar analytes, such as hydrocarbons, for example.

Laser-induced acoustic desorption (LIAD) involves firing laser pulses at a metal foil or some other suitable target. Energy from the laser pulses propagates through the foil, often as acoustic waves, to evaporate neutral analyte molecules deposited an opposite side of the foil. Following desorption with LIAD, the molecules are ionized by electron impact or chemical ionization or by some other suitable method. In particular, LIAD is typically coupled with a post-ionization method, such as electron ionization (EI) or chemical ionization (CI), for example. A combination of LIAD with an ionization method may be used for mass spectrometric analysis of various analytes, such as, for example, biomolecules (e.g., nucleotides and peptides) and petroleum samples (e.g., saturated hydrocarbons, base oil fractions, and asphaltenes). In some systems, LIAD is used with high vacuum mass spectrometers. In other systems, LIAD is coupled to atmospheric pressure ionization sources, such as ESI and atmospheric pressure chemical ionization (APCI). LIAD coupled with ESI often has a strong bias in ionization efficiency towards the most polar compounds. LIAD coupled with APCI has been used to examine a variety of analytes ranging, for example, from polar molecules to nonpolar hydrocarbons. In current systems, some typical limitations associated with LIAD coupled with APCI include poor reproducibility, the sampling of only a small portion of the analyte molecules deposited on the foil surface, and the inability to desorb large thermally labile molecules (e.g., asphaltenes).

Higher laser power densities produce stronger acoustic waves, potentially facilitating desorption of larger analytes. Some high power probes have multiple optics (e.g., mirrors) that result in a long laser beam path. Further, some probe mirrors are manually aligned without the ability for fine adjustments, making alignment cumbersome. Further, vibrations and/or foil replacement in the probe may potentially cause drift in the alignment.

In many LIAD systems, only a portion of the foil's total surface area is exposed to the laser irradiation. Thus, much of the analyte deposited on the foil is not sampled during the mass spectrometry analysis.

The uniformity of the layer of the deposited analyte on the target (e.g., foil) influences the reproducibility of LIAD. Two known methods of depositing the sample on the foil include electrospray deposition and the dry drop technique. Electrospray deposition is amenable to polar molecules. Thus, nonpolar analytes, such as petroleum distillate cuts or asphaltenes, for example, are typically not deposited using electrospray. Nonpolar analytes are often deposited onto foils using a dry drop technique. However, the dry drop technique often deposits non-uniform layers of analyte on the foils. The foil may be rotated to redistribute the analyte solution over the foil, but such rotation is a tedious and difficult process as rotating too slowly will not redistribute the analyte solution and rotating too vigorously will cause the solution to spill off the foil or to accumulate at the edges of the foil. Further, some analytes may undergo thermal degradation during this process, as the foil is gently heated to facilitate evaporation of solvent from the foil's surface. In addition, current foils are prepared with a single analyte, thus requiring a different foil for each analyte to be analyzed.

According to an illustrated embodiment of the present disclosure, a method is provided for preparing a target surface with an analyte sample for analysis with a mass spectrometer. The method includes providing a target preparation device and a target. The target preparation device includes a housing having a cavity. The target is positioned in the cavity of the housing and has a target surface. The method further includes introducing an analyte solution into the cavity of the housing such that the analyte solution is in contact with the target surface. The analyte solution includes an analyte and a solvent. The method further includes delivering a drying gas into the cavity of the housing to evaporate the solvent of the analyte solution and to deposit the analyte onto the target surface.

According to another illustrated embodiment of the present disclosure, a system is provided for preparing a target surface with an analyte sample for analysis with a mass spectrometer. The system includes a target having a target surface. The system further includes a target preparation device including a housing having a cavity. The target is positioned in the cavity of the housing. The system further includes an analyte solution positioned in the cavity of the housing and in contact with the target surface. The analyte solution includes an analyte and a solvent. The system further includes an injection device operative to deliver a drying gas into the cavity of the housing to evaporate the solvent of the analyte solution. The evaporation of the solvent of the analyte solution deposits the analyte onto the target surface.

According to yet another illustrated embodiment of the present disclosure, a foil preparation device is provided for preparing a target foil with an analyte. The foil preparation device includes a housing having an interior cavity. The housing includes at least one wall providing an access to the interior cavity. The foil preparation device further includes a foil holder positioned in the interior cavity of the housing. The foil holder is configured to hold a target foil. The target foil includes a foil surface. The housing is configured to hold an analyte solution in the interior cavity in contact with the foil surface. The access of the at least one wall is configured to receive an injection device for delivering a drying gas into the interior cavity of the housing for evaporation of the analyte solution. The foil holder is positioned in the housing such that the evaporation of the analyte solution deposits an analyte sample onto the foil surface.

### BRIEF DESCRIPTION OF THE DRAWINGS

The detailed description particularly refers to the accompanying figures in which:

FIG. 1 is a perspective view of an exemplary LIAD probe according to one embodiment of the present disclosure;

FIG. 2 is a graph illustrating exemplary mass spectra generated using a LIAD system coupled with electron impact (EI) ionization (top spectrum) and a LIAD system coupled with APCI (bottom spectrum);

FIG. 3 is a front perspective view of an exemplary raster assembly according to one embodiment for use with the LIAD probe of FIG. 1;

FIG. 4 is a front perspective view of another exemplary raster assembly according to one embodiment for use with the LIAD probe of FIG. 1;

FIG. 5 is a rear perspective view of the exemplary raster assembly of FIG. 3;

FIG. 6 illustrates an exemplary foil sample analyzed using the raster assembly of FIG. 3 and an exemplary foil sample analyzed using a conventional foil holder;

FIG. 7 is a graph illustrating a total ion current as a function of time detected in an exemplary analyte ionization experiment;

FIG. 8 is a graph illustrating an exemplary mass spectrum resulting from an exemplary analyte ionization experiment;

FIG. 9A is a perspective view of an exemplary housing of a target preparation device according to an embodiment;

FIG. 9B is a perspective view of an exemplary target holder of a target preparation device according to an embodiment;

FIG. 9C is a perspective view of an exemplary mandrel of a target preparation device according to an embodiment;

FIG. 9D is a perspective view of another exemplary mandrel of a target preparation device according to an embodiment;

FIG. 9E is a perspective view of an exemplary lid of a target preparation device according to an embodiment;

FIG. 10A is a top plan view of the exemplary housing of FIG. 9A;

FIG. 10B is a top plan view of the exemplary target holder of FIG. 9B;

FIG. 10C is a bottom plan view of the exemplary mandrel of FIG. 9C;

FIG. 10D is a bottom plan view of the exemplary mandrel of FIG. 9D;

FIG. 10E is a bottom plan view of the exemplary lid of FIG. 9E;

FIG. 11 is a top plan view of the exemplary lid of FIG. 9E including a septum;

FIG. 12 is a diagrammatic view of an injection device and an exhaust device for delivering a drying gas into the target preparation device of FIGS. 9A-9E; and

FIG. 13 is a graph illustrating two exemplary total ion currents as a function of time detected in an exemplary analyte ionization experiment.

### DETAILED DESCRIPTION OF THE DRAWINGS

For the purposes of promoting an understanding of the principles of the invention, reference will now be made to certain illustrated embodiments and specific language will be used to describe the same. It will nevertheless be understood that no limitation of the scope of the invention is thereby intended. Such alterations and further modifications of the invention, and such further applications of the principles of the invention as described herein as would normally occur to one skilled in the art to which the invention pertains, are contemplated, and desired to be protected in the claims.

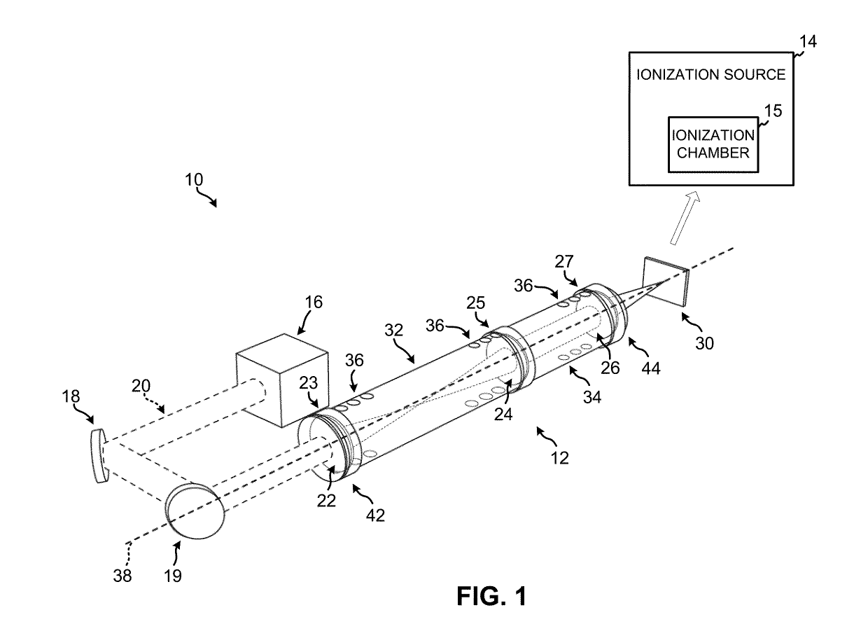

Referring now to the drawings, FIG. 1 illustrates a laser-induced acoustic desorption (LIAD) system 10 which is configured to be coupled to an ionization source 14, such as a mass spectrometer, shown diagrammatically in FIG. 1. In one embodiment, ionization source 14 includes a linear quadrupole ion trap (LQIT) with an atmospheric pressure chemical ionization (APCI) source. Ionization source 14 may include any other suitable type or form of mass spectrometry system. For example, another suitable ionization source 14 includes an atmospheric pressure photo ionization (APPI) source or other type of atmospheric ionization source. LIAD system 10 includes an LIAD probe 12, a laser 16, and kinematically mounted alignment mirrors 18, 19 all supported by a support structure (not shown). Laser 16 is operative to generate a laser beam 20 that is reflected by mirrors 18, 19 through probe 12, as illustrated in FIG. 1. One exemplary type of laser 16 is a neodymium-doped yttrium aluminum garnet (Nd:YAG) laser, such as a Q-pulsed Minilite laser from Continuum.

In the illustrative embodiment, LIAD probe 12 includes two tubes 32, 34 and three lens holders 23, 25, 27. Tubes 32, 34 are illustratively made of brass, although other suitable material may be used. Lens holders 23, 25 are coupled (e.g., threaded) to the respective ends of first tube 32, as illustrated in FIG. 1. Lens holder 23 contains a first telecentric lens 22, and lens holder 25 contains a second telecentric lens 24. In the illustrated embodiment, tube 32 acts as a spacer by positioning lenses 22, 24 apart from each other. In one embodiment, the distance between lenses 22, 24 provided with tube 32 is twice the focal length of lenses 22, 24 such that laser beam 20 is focused by the first lens 22 and recollimated by the second lens 24, as illustrated in FIG. 1. One end of tube 34 is coupled (e.g., threaded) to lens holder 25. A third lens holder 27 is coupled to the opposite end of tube 34 and contains a focusing lens 26. Lens 26 is configured to focus the laser beam 20 onto the backside of a target 30, illustratively a foil 30. In one embodiment, lens 26 is adjustable in a direction along longitudinal (desorption) axis 38 for varying the distance of focusing lens 26 from foil 30. As such, the focal volume and power density of laser beam 20 at the backside of foil 30 can be adjusted. In one embodiment, lens 22, 24, 26 are plano-convex lenses, although other types of lens may be provided. Lens 22, 24, 26 are illustratively all centered about longitudinal axis 38 of probe 12. As such, laser beam 20 has a direct path from mirror 19 to foil 30 along axis 38 without re-direction, i.e., probe 12 illustratively does not include internal mirrors that redirect beam 20 off-axis. Tubes 32, 24 illustratively include holes 36 drilled along the length of tubes 32, 34 to allow for internal venting/cooling when the laser 16 is fired. In one embodiment, such cooling minimizes internal heating and thus minimizes or reduces the expansion of the metal lens holders 23, 25, 27 and spacer tubes 32, 34.

LIAD probe 12 is configured to focus and re-collimate laser beam 20 as it travels from the laser head to the backside of foil 30 by using a pair of telecentric lenses 22, 24, with a third lens 26 used to focus the laser beam 20 onto the backside of the foil 30. By focusing and re-collimating laser beam 20, beam divergence is minimized to reduce the likelihood of losses in laser power density over the beam path. In one embodiment, the beam path from laser 16 to foil 30 provided with LIAD system 10 is approximately three feet in length. In one embodiment, tubes 32, 34 are each approximately 295 millimeters (mm) in length and have an outer diameter of about 0.75 inches, and lens holders 23, 25, 27 are each approximately 0.5 inches in length and include an aperture having about a 0.5 inch inner diameter. In one embodiment, lenses 22, 24, 26 have a 0.5 inch diameter and a focal length of about 150 mm. Other suitable sizes of the components of probe 12 may be provided.

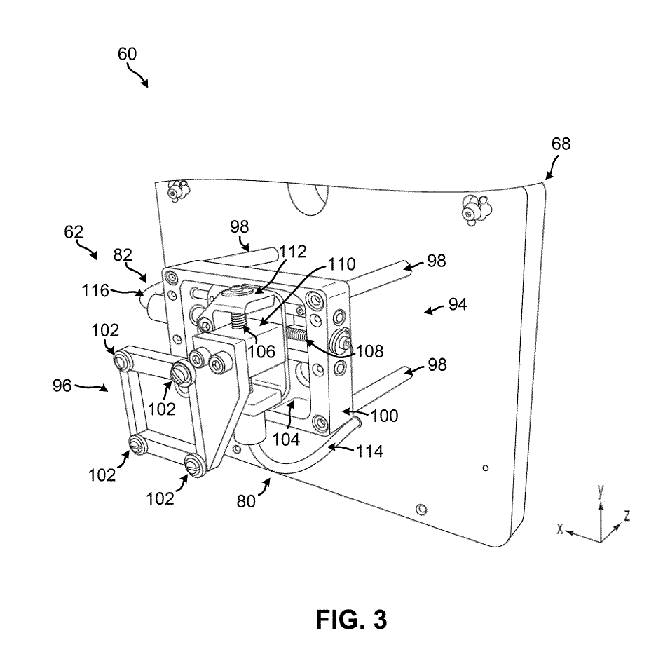

One end 44 of probe 12 is configured to slide into an adapter or holder 64 provided with a raster assembly 60 (see FIG. 3), which bolts onto an atmospheric pressure ionization chamber 15 of ionization source 14 (shown diagrammatically in FIG. 1). In one embodiment, the other end 42 of probe 12 is supported by a holder (not shown) having a U-shaped opening that receives tube 32. The holder may be affixed to a stand secured to a table top or other surface, for example. In one embodiment, the distance between the ionization chamber 15 of ionization source 14 and the externally mounted mirrors 18, 19 is such that probe 12 can be removed from holder 64 (FIG. 3) without moving the external optics (i.e., mirrors 18, 19). As such, foil samples may be changed without realigning the optics 18, 19 for each new foil sample.

In one embodiment, since the lens pair 22, 24 of probe 12 focuses and re-collimates the laser beam 20, the likelihood of power loss over the path of beam 20 is reduced. In one exemplary embodiment, probe 12 results in a loss of about 2% of the initial laser power provided with laser 16. In one embodiment, the higher laser power throughput facilitates efficient evaporation of heavy analytes into the gas phase. In one embodiment, high throughput LIAD probe 12 is configured to increase the maximum laser power density at the backside of the LIAD foil 30 by minimizing divergence of beam 20. In one exemplary embodiment, a maximum power density of about 8200 megawatts per square centimeter (MW/cm²) at the backside of foil 30 is achieved with probe 12.

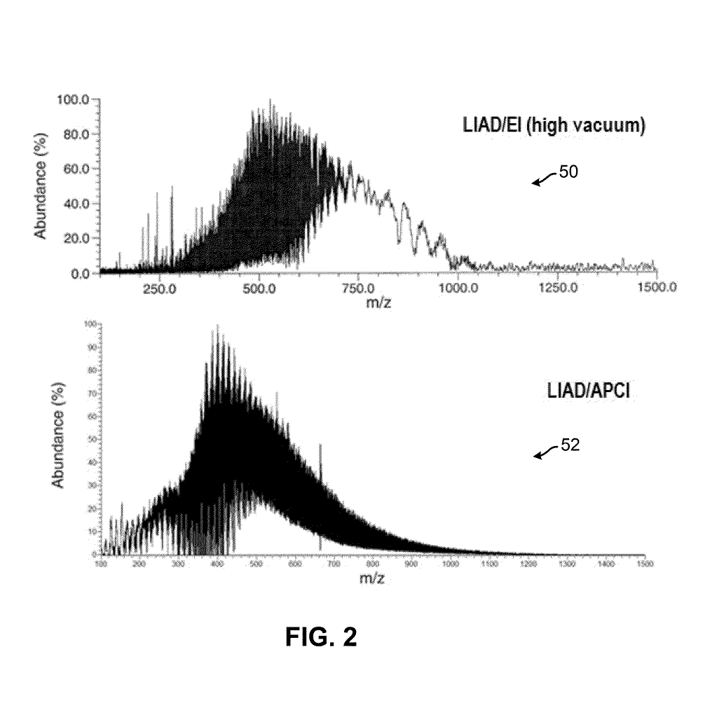

FIG. 2 illustrates performance results from an exemplary ionization experiment with the high throughput probe 12. Referring to FIG. 2, two exemplary mass spectra 50, 52 are illustrated for a same asphalteness sample showing intensity (relative abundance percentage) on the y-axis and a mass-to-charge ratio m/z on the x-axis. Mass spectrum 50 is generated using a LIAD system combined with electron impact (EI) ionization (e.g., high vacuum LIAD/EI system at 70 electron Volts (eV)). Mass spectrum 52 is generated using a LIAD/APCI system with probe 12. Mass spectrum 52 of FIG. 2 is measured for an asphaltenes sample dissolved in carbon disulfide (approximately 1 mg/mL) and deposited on a titanium foil (e.g., foil 30 of FIG. 1) by using the dry drop method. To produce the mass spectrum 52 of FIG. 2, foil 30 is attached to the stage of the raster assembly 60 (described below with FIGS. 3-5) with the analyte desorbed using LIAD probe 12. The gaseous analyte is ionized using APCI with nitrogen (N₂) as the ionization reagent gas (e.g., in a LQIT) wherein N₂ generated by Corona discharge abstracts an electron from an analyte molecule, thus generating a radical cation of the analyte. The resulting mass spectrum 52 shows a molecular weight distribution starting at an m/z of about 200 and ending at an m/z of about 1050. By using the high throughput probe 12 in the LIAD/APCI setup that produces mass spectrum 52, the asphaltenes are desorbed into the gas phase for ionization. The molecular weight distributions of the two mass spectra 50, 52 are illustratively in good agreement.

Referring to FIG. 3, an exemplary rastering assembly 60 is illustrated for use with LIAD system 10. Rastering assembly 60 holds foil 30 (FIG. 1) in position during application of laser beam 20 through probe 12. Rastering assembly 60 includes an adjustable sample holder 62 and a probe holder 64 each coupled to a mounting wall 68. The adjustability of sample holder 62 allows any portion of foil 30 to be sampled. In some embodiments, greater portions of foil 30 being sampled results in an increase in the total generated ion signal and enables multiple experiments with more than one analyte per foil 30. Rastering assembly 60 allows for the movement of foil 30 in the x and y directions, illustratively while using a fixed laser beam path geometry with probe 12, such that the entire or the majority of the surface of foil 30 may be sampled. Further, rastering assembly 60 allows the position of the high throughput LIAD probe 12 to be adjustable in the z-direction (desorption axis 38 of FIG. 1) such that the focal volume and power density of laser beam 20 at the backside of foil 30 is adjustable. Further, rastering assembly 60 allows for foils 30 to be changed without disturbing the optical components (e.g., mirrors 18, 19 and lens 22, 24, 26 of FIG. 1) of the LIAD setup, as described herein.

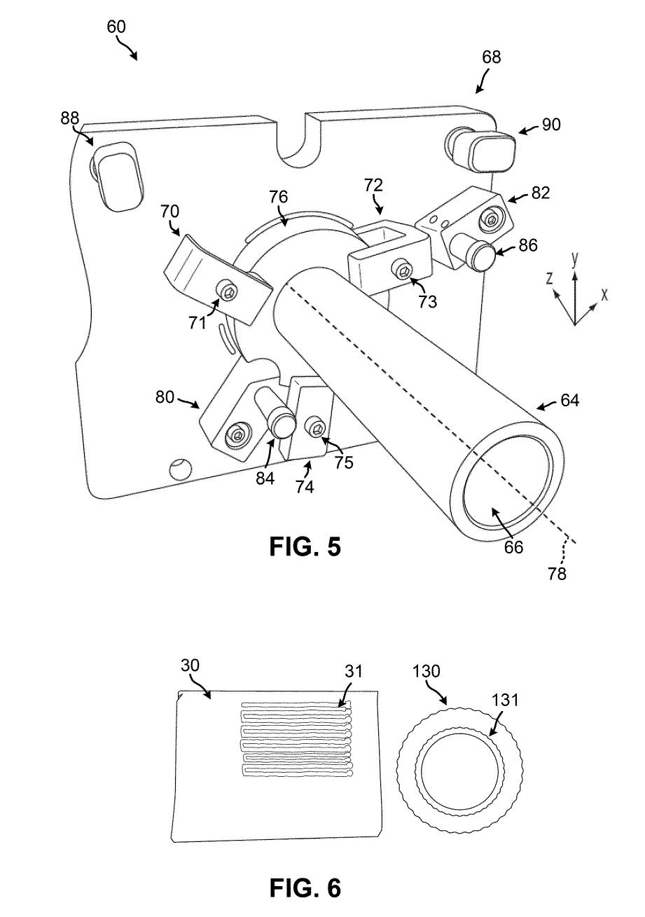

Referring to FIG. 5, raster assembly 60 includes a probe holder 64 having an opening 66 sized to receive end 44 of probe 12 (FIG. 1). In one embodiment, probe holder 64 has an inner diameter (centered about longitudinal axis 78) sized similar to the outer diameter of probe 12 such that end 44 of probe 12 fits securely in probe holder 64. An exemplary inner diameter of probe holder 64 is about 0.75 inches. In the illustrated embodiment, probe holder 64 is adjustable. As illustrated in FIG. 5, probe holder 64 is coupled to mounting wall 68 of rastering assembly 60 via several fasteners 70, 72, 74, illustratively clamps 70, 72, 74. Clamps 70, 72, 74 are fixed to wall 68 and are adjusted via respective screws 71, 73, 75 to clamp onto a flanged base 76 of probe holder 64. Clamps 70, 72, 74 are loosened (via screws 71, 73, 75) to allow probe holder 64 to move or slide in the x- and y-directions to a desired position. In particular, with screws 71, 73, 75 loosened to reduce the clamping pressure on base 76 by clamps 70, 72, 74, the position of probe holder 64 in the x-y plane is adjustable. Upon adjustment of holder 64 to the desired position in the x-y plane, clamps 70, 72, 74 are tightened to secure probe holder 64 in position. As such, the location of the tip of probe 12 may be optimized in the x-y plane for efficient ionization by adjusting the position of probe holder 64. For example, the position of the tip of probe 12 may be adjusted such that the path of beam 20 overlaps with the tip of a corona discharge needle of the ionization source 14 (FIG. 1).

In the illustrated embodiment, rastering assembly 60 further allows probe 12 to be moved along the z-axis to change the focal volume and power density of the laser beam at the backside of the foil 30. In one embodiment, probe 12 is moveable in the z-direction along axis 78 by manually sliding probe 12 within aperture 66 to the desired position. In one embodiment, rastering assembly 60 includes an adjustment device that is manipulated by a user (or automatically by a motor or other suitable drive) to move the position of probe holder 64 and/or probe 12 along axis 78 and/or the position of probe holder 64 in the x- and y-directions. In one embodiment, probe holder 64 is made of brass, although other suitable materials may be used. In one exemplary embodiment, probe holder 64 houses up to 3.75 inches of the end 44 of probe 12.

In the illustrated embodiment, raster assembly 60 is configured to attach to the front of ionization chamber 15 of ionization source 14 (FIG. 1). In one embodiment, raster assembly 60 replaces a front access door of the ionization chamber 15 while using the original fastening hardware for attachment. For example, raster assembly 60 bolts directly onto the ionization chamber 15 in place of its original front access door. As illustrated in FIG. 5, raster assembly 60 includes 90-degree lock pins 88, 90 for locking raster assembly 60 onto ionization chamber 15. In one embodiment, assembly 60 uses the same bolts and lock pins 88, 90 as the original door of ionization chamber 15. An exemplary ionization chamber 15 is the Ion Max box of the Finnigan LQIT.

Referring again to FIG. 3, sample holder 62 includes a base 94 coupled to mounting wall 68 and a target stage 96 moveably coupled to base 94. Base 94 includes a platform 100 and a plurality of legs 98 supporting the platform 100 on the wall 68. In the illustrated embodiment, the raised platform 100 positions the LIAD stage close to the ionization region within ionization source 14 (FIG. 1). Stage 96 supports foil 30 of FIG. 1. In the illustrated embodiment, four fasteners 102 (e.g., screws with washers) are tightened to hold foil 30 in place in stage 96 (i.e., foil 30 is clamped between the washers and stage 96). Base 94 of sample holder 62 further includes an adjustment mechanism 104 that includes perpendicular rods 106, 108 and a pair of sliding portions 110, 112 that receive the respective rods 106, 108. Sliding portion 110 includes inner threads that mate with threads of rod 106, and sliding portion 112 includes inner threads that mate with threads of rod 108. Adjustment mechanism 104 is configured to adjust the position of foil stage 96, and thus foil 30, in the x- and y-directions. In particular, foil stage 96 is mounted to sliding portion 110. Sliding portion 110 is adjustable in the y-direction along rod 106, while sliding portion 112 is adjustable in the x-direction along rod 108. The rotation of rods 106, 108 causes the respective sliding portions 110, 112 to translate along the rods 106, 108. In the illustrated embodiment, the threaded rods 106, 108 are coupled to and driven by respective adjustment devices 80, 82, illustratively cable drives 80, 82. Cable drive 80 includes a cable 114 coupled at one end to rod 106 and at the other end to knob 84 (see FIG. 5) mounted on the front side of raster assembly 60. Similarly, cable drive 82 includes a cable 116 coupled at one end to rod 108 and at the other end to knob 86 (see FIG. 5) mounted on the front side of raster assembly 60. As such, turning knob 84 moves foil stage 96 in the y-direction (i.e., vertically), while turning the other knob 86 moves foil stage 96 in the x-direction (i.e., horizontally). With foil stage 96 being adjustable in the x- and y-directions, the majority of or the entire foil 30 may be sampled with ionization source 14. In another embodiment, adjustment mechanism 104 is automated by using electric motors and computer control logic for controlling the motors.

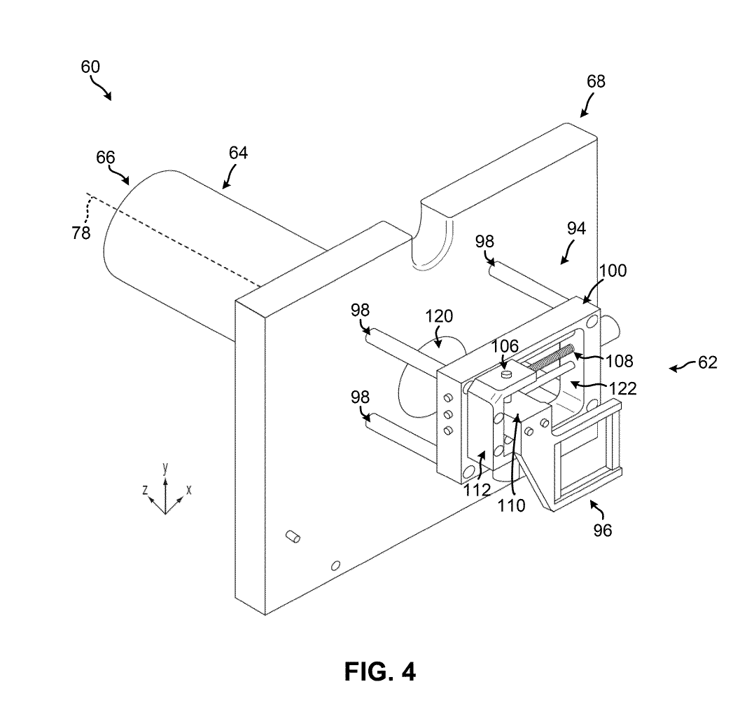

FIG. 4 illustrates another exemplary configuration of the sample holder 62 of FIG. 3. Referring to FIG. 4, foil stage 96 of sample holder 62 is flipped on rod 106 such that stage 96 is rotated 180 degrees relative to base 94 as compared to the configuration of FIG. 3. As illustrated in FIG. 4, laser beam 20 (FIG. 1) is directed through opening 120 of mounting wall 68, through opening 122 of base 94, and onto the backside of a foil 30 (FIG. 1) positioned in foil stage 96.

Rastering assembly 60 of FIGS. 3-5 facilitates sampling of a large surface area of the LIAD foil 30. For example, FIG. 6 illustrates a foil 30 analyzed with LIAD system 10 (FIG. 1) and rastering assembly 60 as well as a foil 130 analyzed by a conventional LIAD system. Foil 30 includes a large surface area 31 that was exposed to laser irradiation from laser 16 (FIG. 1). In particular, laser beam 20 was fired at area 31 of foil 30 during the desorption phase to generate the row-based burn pattern illustrated at area 31. Additional surface area of foil 30 may be sampled by further adjusting foil stage 96 of rastering assembly 60. Foil 130, on the other hand, has a smaller surface area 131 exposed to laser irradiation. For example, in the conventional LIAD system, the position of foil 130 (and laser beam 20) is fixed in the x- and y-directions, so foil 130 is rotated about an axis to generate the circular burn pattern illustrated at area 131 of foil 130.

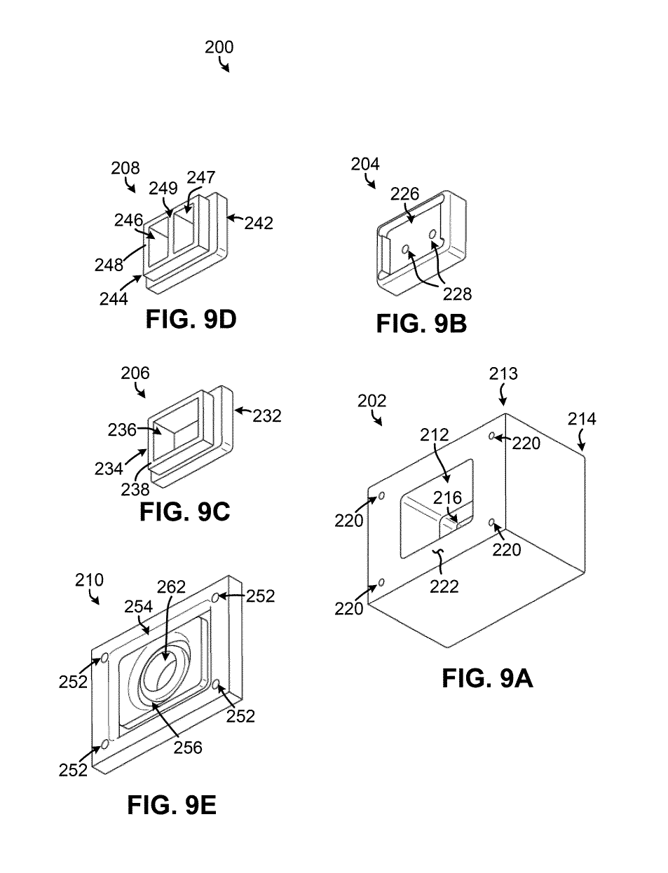

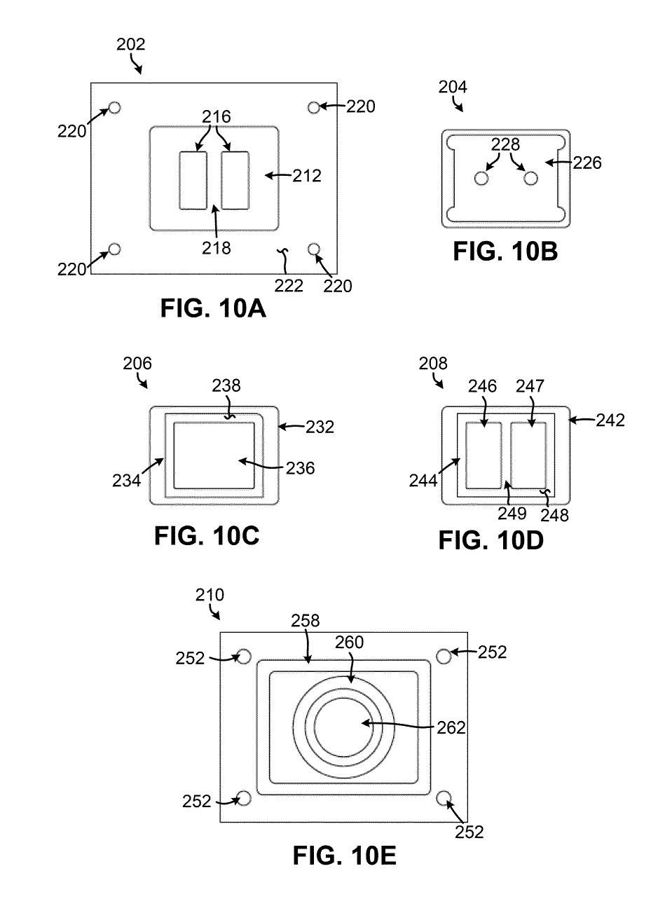

In one embodiment, in the exemplary foil 30 of FIG. 6, about half of surface area 31 is unused (not exposed to the laser irradiation) due to the spacing between the rows of area 31 where the laser irradiates foil 30. Such spacing between irradiated rows serves to reduce the likelihood of overlap between consecutive laser shots (i.e., between consecutive rows) such that a maximum amount of analyte molecules is desorbed and analyzed with each laser shot. In one embodiment, multiple analytes are deposited on foil 30 in separate areas of foil 30 to provide for the analysis of multiple samples per foil 30, such as by using target preparation device 200 of FIGS. 9A-10E described herein. Each sample may be a different analyte or the same analyte. In one embodiment, depositing and analyzing multiple analytes on a single foil 30 serves to improve sampling throughput.

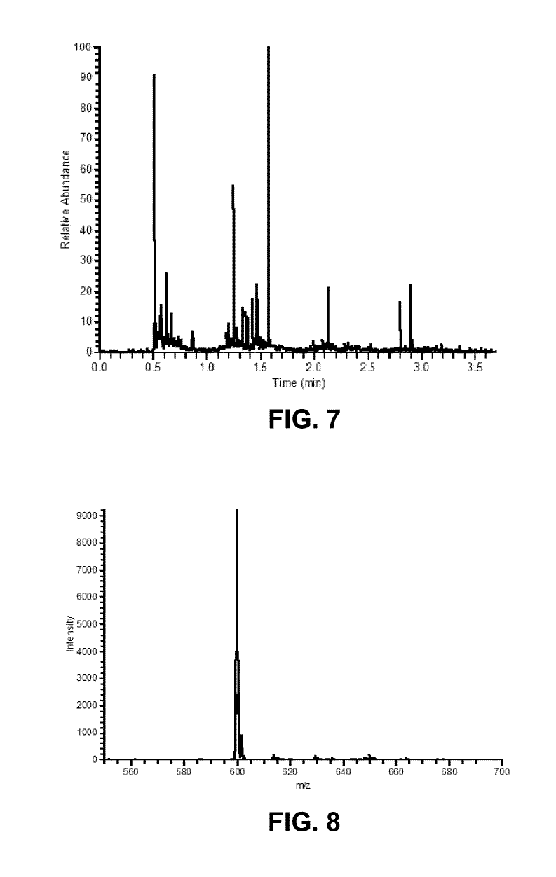

With the ability to sample a large foil surface area using raster assembly 60 of FIGS. 3-5, multiple spectra measured during an LIAD experiment can be averaged to account for uneven sample deposition on the foil surface or a low concentration of sample. FIGS. 7 and 8 illustrate exemplary measured results from one exemplary LIAD experiment using raster assembly 60 of FIGS. 3-5 and LIAD system 10 of FIG. 1. In the exemplary LIAD experiment, about 920 mass spectra were collected for a 3.75 minute experiment that utilized the entire analyte covered surface area of the foil (e.g., foil 30). The foil surface was covered by octaethyl porphyrin (MW=600 Da). The desorbed neutral molecules were ionized using APCI with carbon disulfide as a chemical ionization reagent. FIG. 7 illustrates a total ion current (relative abundance percentage on y-axis) as a function of time (minutes on x-axis). FIG. 8 illustrates the mass spectrum produced by averaging all of the mass spectra collected and shows the intensity on the y-axis and a mass-to-charge ratio m/z on the x-axis. In the exemplary experiment, the laser began firing 0.5 minutes after the start of data collection, allowing for 30 seconds of background to be collected for background subtraction.

FIGS. 9A-9E and 10A-10E illustrate an exemplary target preparation device 200 for preparing a surface of a target, e.g., foil 30, with an analyte. The prepared foil 30 is analyzed with a mass spectrometry system, such as ionization source 14 of FIG. 1. Device 200 is illustratively a preparation chamber including a housing 202, a target holder 204, a forming mandrel 206 (or mandrel 208), and a lid 210. As described herein, device 200 is filled with an analyte solution that contacts the sample surface of foil 30. An inert drying gas is introduced into device 200 to evaporate the solvent from the analyte solution, thereby depositing the analyte onto the surface of the foil 30. In one embodiment, device 200 may be used to prepare foils 30 with either polar or nonpolar analytes.

Housing 202 of FIG. 9A and 10A includes an internal cavity 212 that opens towards a top 213 of the housing 202. Cavity 212 does not extend through the bottom or base 214 of housing 202. Cavity 212 is illustratively centered within housing 202. Within cavity 212 are two wells 216 (see FIG. 10A) that extend towards base 214. In one embodiment, wells 216 collect solvent that may leak past foil 30 during preparation of the foil 30. Fewer or additional wells 216 may be provided. A spacer wall 218 (FIG. 10A) between wells 216 is centered along the length of housing 202. In the illustrated embodiment, a plurality of threaded holes 220 are located at the top 213 of housing 202 for receiving fasteners to secure lid 210 to a top surface 222 of housing 202.

In one exemplary embodiment, housing 202 is a milled block of stainless steel that is about 2.5 inches in length, 1.5 inches in width, and 1.45 inches in height. In one exemplary embodiment, cavity 212 is a substantially rectangular, milled out region of housing 202 that is about 1.3 inches in length, about 1.05 inches in width, and about 0.70 inches in depth (height). In one exemplary embodiment, each well 216 is about 0.7 inches in depth relative to the bottom of the primary cavity 212, about 0.6 inches in length, and about 0.27 inches in width. In one exemplary embodiment, the spacing between wells 216 provided by spacer 218 is about 0.15 inches. In one exemplary embodiment, holes 220 are about one inch deep, are configured to receive bolts or screws, and are located about 0.25 inches from the outer sides of housing 202. Other suitable dimensions and material of housing 202 may be provided.

Foil holder 204 of FIGS. 9B and 10B is sized for insertion into cavity 212. The top surface of foil holder 204 forms a recessed cavity 226. Foil 30 is positioned and held in recessed cavity 226 of holder 204 during the foil preparation. Recessed cavity 226 is illustratively centered on the top surface of foil holder 204. A pair of holes 228 extend through the foil holder 204. In one embodiment, holes 228 allow analyte solution, such as solution that leaks past foil 30, to drain into the solvent collection wells 216 of housing 202. In one embodiment, foil 30 is inserted into holder 204 after insertion of the holder 204 into cavity 212 of housing 202, although foil 30 may be placed into holder 204 prior to positioning holder 204 in cavity 212. In the illustrated embodiment, holder 204 is configured to hold a substantially rectangular foil 30.

In one exemplary embodiment, foil holder 204 is made of Teflon, although other suitable materials may be used. In one exemplary embodiment, foil holder 204 is about 1.3 inches in length and about 1.0 inches in width to fit substantially closely within cavity 212. In one exemplary embodiment, recessed cavity 226 has a depth of about 0.14 inches relative to the top of foil holder 204, a length of about 1.0 inches, and a width of about 0.87 inches. In one exemplary embodiment, holes 228 are about 0.13 inches in diameter and are located about 0.37 inches apart, center to center. In one exemplary embodiment, foil 30 measures about 1.0 inches in length and about 0.84 inches in width and has a thickness of about 12.7 micrometers. Other suitable shapes and dimensions of foil holder 204 and foil 30 may be provided.

Forming mandrel 206 of FIGS. 9C and 10C is configured to be positioned within cavity 212 of housing 202 on top of foil holder 204. Mandrel 206 is illustratively mushroom shaped (when viewed from the side) and includes a top flanged portion 232 and a bottom perimeter wall portion 234. Wall 234 illustratively forms a perimeter around an opening 236 that extends through mandrel 206. Wall 234 is illustratively sized to slide into recessed cavity 226 of foil holder 204. In assembly, bottom surface 238 of wall 234 abuts foil 30 in holder 204 to form a perimeter seal around the foil 30, thereby defining a surface area or region of foil 30 that is exposed to the analyte solution provided through opening 236 of mandrel 206. In the illustrated embodiment, the analyte solution is deposited into opening 236 such that the analyte solution is in contact with the top surface of foil 30.

An alternative forming mandrel 208 is illustrated in FIGS. 9D and 10D. Mandrel 208 is also configured to be positioned within cavity 212 of housing 202 adjacent foil holder 204. Mandrel 208 is illustratively mushroom shaped (when viewed from the side) and includes a top flanged portion 242 and a bottom wall portion 244. Wall 244 includes a bridge 249 that forms two openings 246, 247 that each extend through mandrel 208. Similar to wall 234 of mandrel 206, wall 244 is illustratively sized to slide into recessed cavity 226 of foil holder 204. In assembly, bottom surface 248 of wall 244 abuts foil 30 in holder 204 to form a perimeter seal around two surface areas or regions of foil 30. The two surface regions of foil 30 are exposed to the analyte solution provided through openings 246, 247 of mandrel 208. In the illustrated embodiment, the analyte solution is deposited into openings 246, 247 such that the analyte solution is in contact with the top surface of foil 30. In one embodiment, two different analyte solutions are deposited onto foil 30 via openings 246, 247 of mandrel 208, thereby providing greater sample throughput with mandrel 208. In particular, separate openings 246, 247 allow for the preparation of foil 30 with two different analytes on two separate regions of foil 30. In other embodiments, additional sample areas of foil 30 may be created based on a mandrel 206, 208 having additional openings therethrough.

With foil 30 inserted into recessed portion 226 of foil holder 204, one of mandrels 206, 208 is inserted into cavity 212 of housing 202 such that the respective wall portion 234, 244 slides into recessed portion 226 of holder 204, thereby forming a seal between the respective bottom surface 238, 248 and foil 30.

In one exemplary embodiment, mandrels 206, 208 are made of stainless steel. In one exemplary embodiment, flanged portions 232, 242 of mandrels 206, 208 each have an outer length of about 1.3 inches and an outer width of about 0.99 inches, and perimeter wall portions 234, 244 each have an outer length of about 1.0 inches and an outer width of about 0.85 inches. In one exemplary embodiment, opening 236 of mandrel 206 is substantially rectangular and has a length of about 0.8 inches and a width of about 0.66 inches. In one exemplary embodiment, openings 246, 247 of mandrel 208 each have a length of about 0.35 inches and a width of about 0.66 inches.

Top wall or lid 210 of FIGS. 9E and 10E is configured to be secured to top surface 222 of housing 202. Lid 210 includes a plurality of holes 252 that align with holes 220 of housing 202 and receive the fasteners (e.g., screws or bolts) described above. Lid 210 further includes an outer channel 254 and an inner channel 256 each configured to receive a seal. Outer channel 254 is illustratively rectangular in shape and receives a rectangular o-ring seal 258 (FIG. 10E) for sealing lid 210 against top surface 222 of housing 202. As such, the likelihood of drying gas leaking from cavity 212 past lid 210 during foil preparation is reduced Inner channel 256 is illustratively circular in shape and receives a circular o-ring seal 260 (FIG. 10E). With lid 210 tightened against housing 202, o-ring seal 260 compresses mandrel 206 (or mandrel 208) towards foil holder 204 such that wall 234 of mandrel 206 seals the edges of foil 30, as described above.

In one exemplary embodiment, the inner diameter of o-ring seal 260 is about 0.8 inches, and o-ring seal 260 has a thickness of about 3/32 of an inch. Outer and inner channels 254, 256 are illustratively centered on lid 210. In one exemplary embodiment, channel 254 has a length of about 1.74 inches and a width of about 1.38 inches, and seal 258 has approximately the same dimensions.

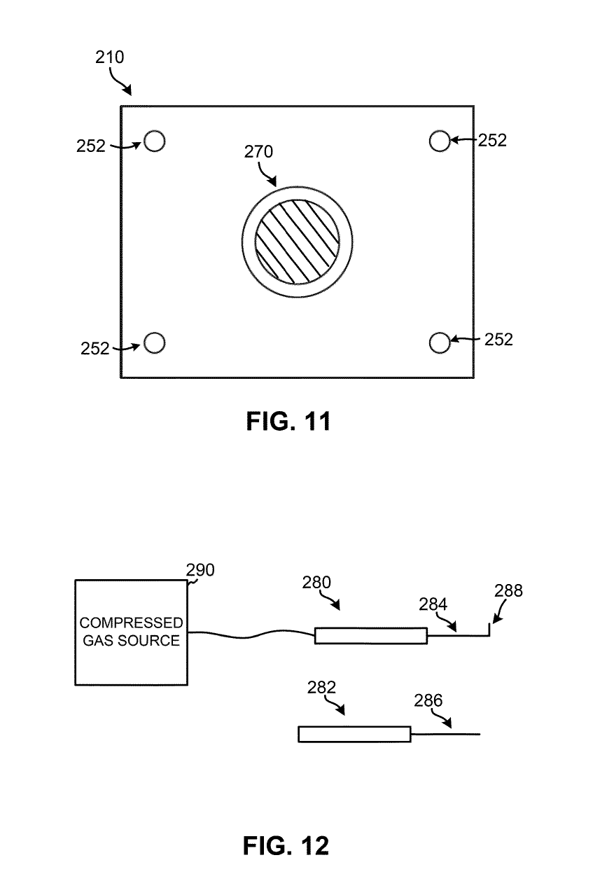

Also centered on lid 210 is a hole 262. Hole 262 is filled with a septum 270 (FIG. 11) to separate the internal cavity 212 of housing 202 from the outside air. FIG. 11 illustrates a top view of lid 210 with septum 270 inserted in hole 262. In one embodiment, septum 270 is made of rubber, although other suitable materials may be used. Septum 270 functions as an access to the internal cavity 212 of housing 202. As described herein, an analyte solution is provided in cavity 212 of housing 202 to cover the foil 30 prior to closing lid 210 and/or inserting septum 270.

Referring to FIG. 12, an injection device 280 and an exhaust device 282 are provided for insertion into septum 270 of FIG. 11 to deliver a drying gas within cavity 212 of preparation device 200. In one embodiment, injection device 280 and exhaust device 282 include needles (e.g., 22-gauge) having respective shafts 284, 286. In the illustrative embodiment, injection needle 280 has a 90-degree bend 288 in shaft 284 so that the needle tip, after piercing septum 270, may be held substantially parallel to foil 30 positioned inside preparation device 200. Injection needle 280 is coupled to a compressed gas source 290 (e.g., gas cylinder) that contains an inert drying gas, such as argon or nitrogen, for example, which is injected into cavity 212 with needle 280 to evaporate the solvent from the analyte solution contained within the housing 202. In one embodiment, bend 288 in shaft 284 of needle 280 serves to direct the drying gas above and substantially parallel to the foil surface. As such, the likelihood of the drying gas flowing directly onto the surface of foil 30, which could create a pocket where the sample solution is blown away by the gas to expose bare foil 30, is reduced or eliminated. Exhaust needle 282, which exhausts or removes drying gas from cavity 212 to avoid pressure buildup, has a substantially straight shaft 286. Other suitable configurations of needles 280, 282 may be provided.

To prepare a foil 30 with preparation device 200, foil 30 is inserted into foil holder 204, and foil holder 204 is inserted into cavity 212 of housing 202, as described above. One of mandrels 206, 208 is inserted on top of foil holder 204, and lid 210 is fastened to housing 202 such that the mandrel 206, 208 forms a perimeter seal around the sample surface(s) of foil 30, as described above. Once device 200 is assembled with foil 30 positioned inside and prior to inserting septum 270, cavity 212 is filled with the analyte solution, such as by using a pipette, for example, until the analyte solution completely covers the sample surface area of foil 30, i.e., a layer of analyte solution covers the sample area of foil 30. The analyte solution includes an analyte mixed with a solvent. In one embodiment, a volatile solvent is used that is conducive to rapid evaporation. Septum 270 is inserted into hole 262 of lid 210, and the two needles 280, 282 are inserted into septum 270. Drying gas is delivered to cavity 212 via injection needle 280 to gently flow drying gas over the analyte solution covering foil 30, i.e., in a direction substantially parallel to and above foil 30. In one embodiment, the flow rate for the drying gas is slow to reduce the likelihood of blowing the analyte solution to the edges of foil 30. Exhaust needle 282 inserted in cavity 212 provides an escape for the drying gas during gas delivery. The drying gas is delivered by injection device 280 for a predetermined amount of time, depending on the type of solvent used and on how quickly the solvent evaporates. For example, in one embodiment, the drying gas is delivered to cavity 212 for about ten minutes. The solvent is evaporated with the drying gas, leaving the analyte sample deposited on the sample surface of foil 30 in a substantially uniform layer. Septum 270 and needles 280, 282 are removed, and the condition of foil 30 may be examined. If a more concentrated sample layer is desired, additional analyte solution may be added to cavity 212, and needles 280, 282 may be re-inserted into cavity 212 to repeat the solvent evaporation and analyte deposition.

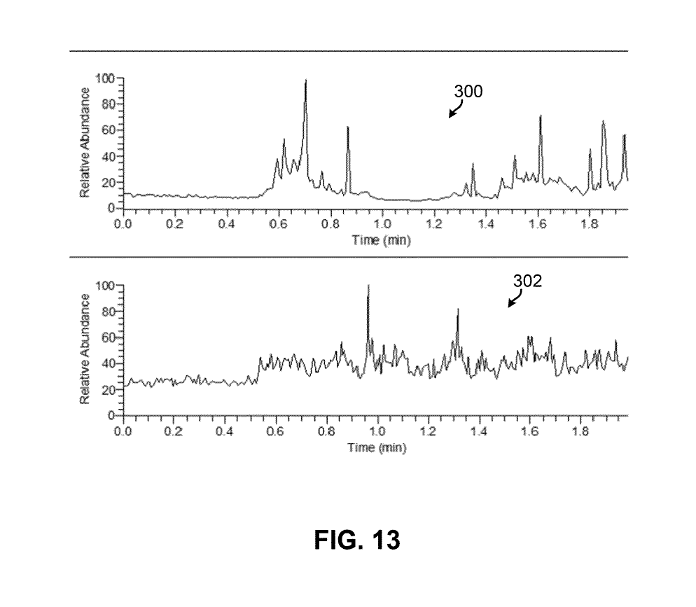

FIG. 13 illustrates two graphs 300, 302 each showing an exemplary total ion current (relative abundance percentage on the y-axis) as a function of time (minutes on the x-axis) provided by a mass spectrometer while LIAD laser beam 20 was rastered over a foil 30. In the illustrated embodiment, the foil 30 associated with each graph 300, 302 was prepared with asphaltenes deposited on the foil surface. Graph 300 illustrates the total ion current produced with a foil 30 prepared using the conventional dry drop method, and graph 302 illustrates the total ion current produced with a foil 30 prepared using the drying gas method provided with target preparation device 200. As illustrated, the foil 30 prepared using the drying gas method (graph 302) shows a more stable total ion current as compared to the foil 30 prepared using the dry drop method (graph 300), thus indicating that a more uniform layer of analyte was deposited on foil 30 using the drying gas method. For example, the sporadic signal illustrated in graph 300 indicates that the analyte layer deposited on foil 30 with the dry drop method is uneven, with areas of heavy analyte sample and areas of little to no analyte sample.

While this invention has been described as having exemplary designs or embodiments, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

Although the invention has been described in detail with reference to certain illustrated embodiments, variations and modifications exist within the scope and spirit of the present invention as described and defined in the following claims.

What is claimed is:

1. A method of preparing a target surface with an analyte sample for analysis with a mass spectrometer, the method comprising:
providing a target preparation device and a target, the target preparation device including a housing having a cavity, the target being positioned in the cavity of the housing and having a target surface;
introducing an analyte solution into the cavity of the housing such that the analyte solution is in contact with the target surface, the analyte solution including an analyte and a solvent; and
delivering a drying gas into the cavity of the housing to evaporate the solvent of the analyte solution and to deposit the analyte onto the target surface.

2. The method of claim 1, wherein the delivering the drying gas includes inserting an injection device into the cavity of the housing to inject the drying gas into the cavity.

3. The method of claim 2, wherein the injection device injects the drying gas into the cavity in a direction substantially parallel to the target surface.

4. The method of claim 2, wherein the housing of the target preparation device includes a septum, wherein the injection device includes a needle that is inserted through the septum and into the cavity of the housing to inject the drying gas into the cavity.

5. The method of claim 4, further including inserting an exhaust device into the cavity of the housing to exhaust drying gas from the cavity of the housing during the delivery of the drying gas, wherein exhaust device includes a needle that is inserted through the septum into the cavity of the housing to exhaust the drying gas from the cavity.

6. The method of claim 1, wherein the drying gas comprises an inert gas.

7. The method of claim 1, wherein the target preparation device further includes a mandrel, the method further comprising positioning the mandrel in the cavity adjacent the target surface to form a perimeter around a sample area of the target surface that receives the deposited analyte.

8. The method of claim 7, wherein the mandrel forms a perimeter around each of a plurality of sample areas of the target surface, and each sample area of the target surface is configured to receive a different analyte.

9. The method of claim 7, wherein the positioning the mandrel includes forcing the mandrel into sealing engagement with the target surface to form the sample area.

10. The method of claim 1, wherein the target comprises a foil.

11. A system for preparing a target surface with an analyte sample for analysis with a mass spectrometer, the system comprising:
a target including a target surface;
a target preparation device including a housing having a cavity, the target being positioned in the cavity of the housing;
an analyte solution positioned in the cavity of the housing and in contact with the target surface, the analyte solution including an analyte and a solvent; and
an injection device operative to deliver a drying gas into the cavity of the housing to evaporate the solvent of the analyte solution, wherein evaporation of the solvent of the analyte solution deposits the analyte onto the target surface.

12. The system of claim 11, wherein the injection device is configured to inject the drying gas into the cavity in a direction substantially parallel to the target surface.

13. The system of claim 11, wherein a wall of the housing of the target preparation device includes a septum, and wherein the injection device includes a needle that is inserted through the septum and into the cavity of the housing to inject the drying gas into the cavity.

14. The system of claim 13, further comprising an exhaust device having a needle, wherein the needle of the exhaust device is inserted through the septum and into the cavity of the housing to exhaust drying gas from the cavity during the delivery of the drying gas into the cavity.

15. The system of claim 11, wherein the target comprises a foil.

16. The system of claim 11, wherein the target preparation device further includes at least one well and a target holder, the target holder is positioned in the cavity of the housing and is configured to hold the target, and the target holder includes at least one aperture for moving analyte solution from the cavity into the at least one well.

17. The system of claim 11, wherein the target preparation device further includes a mandrel having a perimeter wall that forms an opening extending through the mandrel, the perimeter wall of the mandrel abuts the target surface to form a sealing perimeter around a sample area of the target surface, and the analyte solution is provided through the opening of the mandrel to contact the sample area of the target surface.

18. The system of claim 17, wherein the perimeter wall of the mandrel forms a plurality of openings that extend through the mandrel, the perimeter wall of the mandrel abuts the target surface to form a sealing perimeter around a plurality of different sample areas of the target surface, and each sample area of the target surface is configured to receive an analyte solution through a corresponding opening of the mandrel.

19. A foil preparation device for preparing a target foil with an analyte, the device comprising:
a housing having an interior cavity, the housing including at least one wall providing an access to the interior cavity; and
a foil holder positioned in the interior cavity of the housing and configured to hold a target foil, wherein the target foil includes a foil surface, wherein the housing is configured to hold an analyte solution in the interior cavity in contact with the foil surface, wherein the access of the at least one wall is configured to receive an injection device for delivering a drying gas into the interior cavity of the housing for evaporation of the analyte solution, wherein the foil holder is positioned in the housing such that the evaporation of the analyte solution deposits an analyte sample onto the foil surface.

20. The device of claim 19, further comprising a mandrel and at least one well, the mandrel including a perimeter wall that forms at least one opening extending through the mandrel, the perimeter wall of the mandrel abutting the foil surface to form a sealing perimeter around at least one sample area of the foil surface, the at least one opening of the mandrel being configured to receive the analyte solution such that the analyte solution contacts the at least one sample area of the foil surface, the at least one wall being positioned below the target holder, the foil holder including at least one aperture for moving analyte solution from the interior cavity into the at least one well.
